(19) United States
(12) Patent Application Publication
(10) Pub. No.: US 2007/0015658 A1
(43) Pub. Date: Jan. 18, 2007

(54) Fuzz reduction of sulfur sorbents

(76) Inventors: Uday T. Turaga, Bartlesville, OK (US); Tushar V. Choudhary, Bartlesville, OK (US); Jason J. Gislason, Bartlesville, OK (US); Deborah K. Just, Bartlesville, OK (US)

Correspondence Address: ConocoPhilips Company - I.P. Legal, PO BOX 2443, BARTLESVILLE, OK, 74005, US

(21) Appl. No.: 11/182,963

(22) Filed: Jul. 15, 2005

(51) Int. Cl. B01J 20/00

(52) U.S. Cl. 502/400

(57) ABSTRACT

A sorbent composition with reduced nickel fuzz content. The sorbent is effective to remove sulfur from a hydrocarbon-containing stream, such as gasoline or diesel fuel.

### BACKGROUND

This invention relates generally to systems for desulfurizing hydrocarbon-containing fluid streams such as cracked-gasoline and diesel fuel. In another aspect, the invention concerns compositions that can be used to remove sulfur from hydrocarbon-containing fluid streams with minimal octane loss.

Hydrocarbon-containing fluids such as gasoline and diesel fuels typically contain a quantity of sulfur. High levels of sulfur in automotive fuels are undesirable because oxides of sulfur present in automotive exhaust may irreversibly poison noble metal catalysts employed in automobile catalytic converters. Emissions from such poisoned catalytic converters may contain high levels of non-combusted hydrocarbons, oxides of nitrogen, and/or carbon monoxide, which, when catalyzed by sunlight, form ground level ozone, more commonly referred to as smog.

Much of the sulfur present in the final blend of most gasolines originates from a gasoline blending component commonly known as “cracked-gasoline.” Thus, reduction of sulfur levels in cracked-gasoline will inherently serve to reduce sulfur levels in most gasolines, such as automobile gasolines, racing gasolines, aviation gasolines, boat gasolines, and the like. Many conventional processes exist for removing sulfur from cracked-gasoline. However, most conventional sulfur removal processes, such as hydrodesulfurization, tend to saturate olefins and aromatics in the cracked-gasoline and thereby reduce its octane number (both research and motor octane number). Thus, there is a need for a process wherein desulfurization of cracked-gasoline is achieved while the octane number is maintained or even enhanced.

One such method involves the use of sorbent compositions that contain nickel and zinc oxide. However, the preparation of many conventional nickel-containing sorbents results in the formation of nickel “fuzz” on the surface of the sorbent. FIG. 1 illustrates a conventional nickel-containing sorbent prior to use in a desulfurization unit. It can be seen from FIG. 1, that this “fresh” sorbent has a significant quantity of nickel fuzz present on its surface. This nickel fuzz creates problems in both the manufacture and use of the sorbent. Potentially, this nickel fuzz results in an overall reduction of the volumetric desulfurization activity of the sorbent, which requires more sorbent to be added to a desulfurization system.

### OBJECTS AND SUMMARY OF THE INVENTION

It is, therefore, an object of the present invention to provide a nickel-containing sorbent with reduced nickel fuzz content.

Accordingly, one aspect of the present invention concerns a sorbent system comprising a plurality of fresh sorbent particles. The fresh sorbent particles comprise zinc oxide and nickel. The sorbent system has a mean particle size of less than about 500 microns and a nickel fuzz content of less than about 7 percent by volume.

Another aspect of the present invention concerns a sorbent system formed of a plurality of fresh sorbent particles, wherein the sorbent particles comprise: (a) zinc oxide in an amount in the range of from about 10 to about 80 weight percent; (b) a nickel-zinc substitutional solid solution and/or oxide thereof; and (c) a promoter metal selected from the group consisting of magnesium, calcium, barium, cerium, oxides and combinations thereof. The promoter is present in an amount in the range of from about 0.5 to about 10 weight percent. The sorbent system has a mean particle size in the range of from about 10 to about 200 microns.

A further aspect of the present invention concerns a method of producing a sorbent composition, the method comprising the following steps: (a) forming a support mixture comprising zinc oxide and alumina; (b) particulating the support mixture to thereby form a plurality of support particles having a mean particle size less than about 500 microns; (c) incorporating nickel and a promoter metal onto and/or into the support particles to thereby provide promoted particles, wherein said non-nickel promoter is selected from the group consisting of lanthanum, cerium, praseodymium, neodymium, promethium, samarium, europium, gadolinium, terbium, dysprosium, holmium, erbium, thulium, ytterbium, lutetium, lithium, sodium, potassium, rubidium, cesium, francium, beryllium, magnesium, calcium, strontium, barium, radium, oxides thereof, and combinations thereof; and (d) calcining said promoted particles to thereby provide calcined promoted particles.

Still another aspect of the present invention concerns a process for removing sulfur from a hydrocarbon-containing fluid stream. The process comprises the following steps: (a) contacting the hydrocarbon-containing fluid stream with a sorbent composition comprising zinc oxide, nickel, and a non-nickel promoter in a desulfurization zone under conditions such that there is formed a desulfurized fluid stream and a sulfurized sorbent, wherein said non-nickel promoter is selected from the group consisting of lanthanum, cerium, praseodymium, neodymium, promethium, samarium, europium, gadolinium, terbium, dysprosium, holmium, erbium, thulium, ytterbium, lutetium, lithium, sodium, potassium, rubidium, cesium, francium, beryllium, magnesium, calcium, strontium, barium, radium, oxides thereof, and combinations thereof; (b) regenerating at least a portion of the sulfurized sorbent in a regeneration zone so as to remove at least a portion of the sulfur therefrom and provide a desulfurized sorbent; (c) reducing the desulfurized sorbent in an activation zone to provide a reduced sorbent composition which will affect the removal of sulfur from the hydrocarbon-containing fluid stream when contacted with the same; and (d) returning at least a portion of the reduced sorbent composition to the desulfurization zone.

### BRIEF DESCRIPTION OF THE DRAWINGS

FIG. 1 is a magnified view of conventional, fresh nickel-containing sorbent particles having a significant quantity of nickel fuzz on their surfaces.

FIG. 2 is a schematic process flow diagram of a desulfurization unit constructed in accordance with the principals of the present invention, particularly illustrating the circulation of a regenerable solid particulate system through the reactor, regenerator, and reducer.

### DETAILED DESCRIPTION OF THE PREFERRED EMBODIMENTS

One embodiment of the present invention concerns a method of making a nickel-containing sorbent. The sorbent preparation method disclosed herein results in a sorbent having a reduced nickel fuzz content as compared to conventionally prepared nickel-containing sorbents. Generally, the improved sorbent preparation method includes the following steps:
(a) forming a support mixture of water, an acidic medium, zinc oxide, alumina, a filler, and a porosity enhancer;
(b) particulating the support mixture into finely divided support particles;
(c) drying the support particles;
(d) calcining the dried support particles;
(e) incorporating nickel and a non-nickel promoter onto and/or into the calcined support particles to thereby form promoted sorbent particles;
(f) drying the promoted sorbent particles;
(g) calcining the dried promoted sorbent particles; and
(h) reducing the calcined promoted sorbent particles.

In step (a), a support mixture is formed by admixing water, an acidic medium, zinc oxide, alumina, a filler, and a porosity enhancer. The acidic medium is preferably a nitric acid solution, which can contain about 1 percent nitric acid. The filler can be any compound which enhances the ability of the support mixture to be spray dried. Preferably, the filler is a clay such as, for example, kaolin clay. The porosity enhancer can be any compound which ultimately increases the macroporosity of the final sorbent particles. Preferably, the porosity enhancer is perlite. Preferred amounts of water, acidic medium, zinc oxide (ZnO), alumina, filler, and porosity enhancer (PE) used to make the support mixture are summarized below in Table 1.

TABLE 1
Components of the Support Mixture

| | | Acidic | | | | |
|---|---|---|---|---|---|---|
| | Water | Med. | Alumina | ZnO | Filler | PE |
| Range | (wt %) | (wt %) | (wt %) | (wt %) | (wt %) | (wt %) |
| Preferred | 10-80 | 0.1-10 | 10-80 | 2-50 | 1-40 | 2-50 |
| More | 20-60 | 0.4-5 | 15-60 | 4-25 | 2-20 | 4-25 |
| Preferred | | | | | | |
| Most | 30-50 | 0.6-1.5 | 25-45 | 5-15 | 4-12 | 5-15 |
| Preferred | | | | | | |

In step (b), the support mixture is particulated by any method known in the art to thereby provide finely divided support particles. As used herein, the term “finely divided” shall denote particles having a mean particle size of less than about 500 microns. Preferably, the particulating of step (b) causes the formation of particles having a mean particle size in the range of from about 20 to about 200 microns, most preferably in the range of from about 40 to 100 microns. Preferably, the support mixture is particulated by spray drying. Spray drying is known in the art and is discussed in Perry's Chemical Engineers Handbook, 6^{th} Edition, published by McGraw-Hill, Inc. at pages 20-58. Additional information can be obtained from the Handbook of Industrial Drying, published by Marcel Dekker, Inc. at pages 243-293.

In step (c), the support particles are dried by any method known in the art. Preferably, such drying is performed in air for at least 1 hour at a temperature in the range of from about 180 to about 270° F.

In step (d), the dried support particles are calcined by any method known in the art. Preferably, such calcining is performed in air at about atmospheric pressure for a time period of at least 0.5 hours and at a temperature in the range of from about 400 to about 1,800° F. Most preferably, such calcining is performed in air at about atmospheric pressure for a time period in the range of from 1.5 to 20 hours and at a temperature in the range of from about 800 to about 1,500° F. In accordance with one embodiment of the present invention, calcination of the support particles causes at least a portion of the zinc oxide to react with at least a portion of the alumina to thereby form zinc aluminate (ZnAl₂O₄).

In step (e), nickel and a non-nickel promoter are incorporated onto and/or into the calcined support particles to thereby form promoted sorbent particles. The nickel and non-nickel promoter can be incorporated in their elemental form and/or can be incorporated as metal oxides. The nickel and promoter can be incorporated onto and/or into the calcined support particles by any method known in the art for incorporating a metal onto and/or into a solid porous support. A preferred method of incorporating the nickel and promoter onto and/or into the calcined support particles is by incipient wettness impregnation. When incipient wetness impregnation is employed to incorporate the nickel and promoter onto and/or into the calcined support particles, it is preferred for the nickel and promoter to be present in an aqueous solution which is contacted with the calcined support particles. This contacting of the calcined support particles and the aqueous solution causes wetting of the surface and/or pores of the support particles with the aquesous solution. The nickel and the promoter can be simultaneously impregnated onto/into the calcined support particles by employing an aqueous solution containing both nickel and the promoter. Alternatively, the nickel and promoter can be separately impregnated onto/into the support particles by impregnation with separate aqueous solutions—one containing nickel and the other containing the promoter(s).

The promoter used in step (e) is a substance that is effective to reduce the nickel fuzz content of the final sorbent composition. Preferably, the promoter is one or more metals and/or oxides of metals from the lanthanide, alkali, and alkaline earth groups. Thus, it is preferred for the promoter to be the metal and/or metal oxide of one or more of the following metals: lanthanum, cerium, praseodymium, neodymium, promethium, samarium, europium, gadolinium, terbium, dysprosium, holmium, erbium, thulium, ytterbium, lutetium, lithium, sodium, potassium, rubidium, cesium, francium, beryllium, magnesium, calcium, strontium, barium, and radium. More preferably, the promoter is the metal and/or metal oxide of one or more of the following metals: magnesium, calcium, barium, and cerium. Still more preferably, the promoter is calcium, calcium oxide, cerium, and/or cerium oxide. Most preferably, the promoter is cerium or cerium oxide. In one embodiment of the invention, it is preferred for the promoter to be present as a metal oxide.

The aqueous solution(s) used in step (e) to incorporate nickel and the promoter onto/into the calcined support particles preferably contain nitrates of nickel and the promoter. For example, nickel nitrate hexahydrate in water can be employed as the nickel-containing aqueous solution. When magnesium is employed as the promoter, the promoter-containing aqueous solution can be magnesium nitrate hexahydrate in water. When calcium is employed as the promoter, the promoter-containing aqueous solution can be calcium nitrate tetrahydrate in water. When cerium is employed as the promoter, the promoter-containing aqueous solution can be cerium nitrate hexahydrate in water. When barium is employed as the promoter, the promoter-containing aqueous solution can be barium nitrate in water. When multiple promoters are used, it is preferred for the promoters to be co-impregnated onto/into the support particles by mixing the various promoter-containing aqueous solutions and then using the aqueous mixture to impregnate the support particles. Further, it is preferred for the nickel and the promoter(s) to be co-impregnated onto/into the support particles by mixing the nickel-containing aqueous solution with the promoter-containing aqueous solution(s) and then using the resulting aqueous mixture to impregnate the support particles.

The amount of nickel and/or nickel oxide incorporated onto and/or into the support particles is preferably such that the promoted support particles contain about 5 to about 50 weight percent nickel and/or nickel oxide, more preferably about 8 to about 40 weight percent nickel and/or nickel oxide, and most preferably 10 to 25 weight percent nickel and/or nickel oxide. The total amount of promoter(s) and/or oxides thereof incorporated onto and/or into the support particles is preferably such that the promoted support particles contain about 0.5 to about 10 weight percent promoter(s) and/or oxides thereof, more preferably about 1 to about 5 weight percent promoter(s) and/or oxides thereof, and most preferably 1.25 to 3 weight percent promoter(s) and/or oxides thereof.

In step (f), the promoted sorbent particles are dried by any conventional method known in the art. Preferably, such drying is performed in air for at least 1 hour at a temperature in the range of from about 180 to about 270° F.

In step (g), the dried promoted sorbent particles are calcined by any method known in the art. Preferably, such calcining is performed in air at about atmospheric pressure for a time period of at least 0.5 hours and at a temperature in the range of from about 400 to about 1,800° F. Most preferably, such calcining is performed in air at about atmospheric pressure for a time period in the range of from 1.5 to 20 hours and at a temperature in the range of from 800 to about 1,500° F.

In a preferred embodiment of the present invention, calcination of the promoted sorbent particles causes at least a portion of the nickel and/or nickel oxide to react with at least a portion of the zinc oxide to thereby form a nickel-zinc oxide substitutional solid solution. This nickel-zinc oxide substitutional solid solution can be characterized by the formula Ni_{X}Zn_{(1-X)}O, wherein X is in the range of from about 0.01 to about 0.99. Further, it is preferred for the calcining to cause at least a portion of the nickel and/or nickel oxide to react with at least a portion of the zinc aluminate (ZnAl₂O₄) to thereby form a nickel-zinc aluminate substitutional solid solution. This nickel-zinc aluminate substitutional solid solution can be characterized by the formula Ni_{Z}Zn_{(1-Z)}Al₂O₄, wherein Z is in the range of from about 0.01 to about 0.99. The calcined promoted sorbent particles preferably contain zinc oxide, nickel-zinc oxide (Ni_{X}Zn_{(1-X)}O), nickel-zinc aluminate (Ni_{Z}Zn_{(1-Z)}Al₂O₄), the promoter (as the elemental metal and/or the metal oxide), and the porosity enhancer (PE) in the ranges provided below in Table 2.

TABLE 2
Components of the Calcined Promoted Sorbent Particles

| | | Ni_{X}Zn₍₁₋ₓ₎O | Ni_{Z}Zn_{(1-Z)}Al₂O₄ | Promoter | |
|---|---|---|---|---|---|
| Range | ZnO (wt %) | (wt %) | (wt %) | (wt %) | PE (wt %) |
| Preferred | 10-80 | 5-70 | 1-50 | 0.5-10 | 2-50 |
| More Preferred | 20-60 | 15-60 | 5-30 | 1-5 | 5-30 |
| Most Preferred | 30-50 | 20-40 | 10-20 | 1.25-3 | 10-20 |

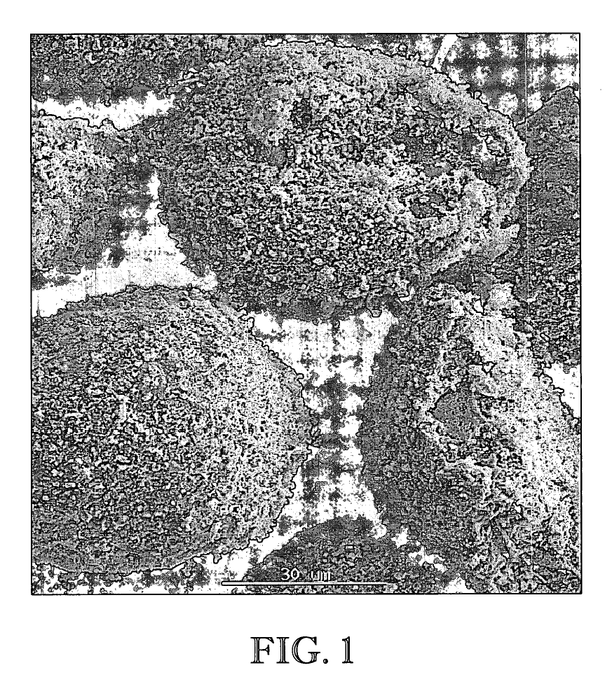

The inventors have discovered that when the promoter is not incorporated into the sorbent composition, the calcined promoted sorbent particles contain an excessive amount of nickel fuzz. As illustrated in FIG. 1, nickel fuzz is a layer of loosely bound small particles that are present at the surface of the calcined promoted sorbent particles. As discussed above, the presence of nickel fuzz on the calcined promoted sorbent particles is undesirable for a number of reasons. In particular, nickel fuzz is undesirable because it falls off of the sorbent particles when the sorbent particles are placed in a reactor and used for their intended purpose of desulfurizing a hydrocarbon-containing stream.

The presence of the promoter reduces the nickel fuzz content of the calcined promoted sorbent particles. As used herein, the term “nickel fuzz content” shall mean the volume percent of sub 20 micron particles present in a system of fresh solid particles measured in a Malvern Mastersizer 2000™ particle size analyzer in accordance with the test procedure described immediately below. The term “fresh,” when used herein to modify a system of solid particles (e.g., “fresh promoted sorbent particles”), shall mean that the particles have not yet been loaded in a reactor or subjected to any other type of agitation that would cause more than 10 volume percent to the nickel fuzz originally attached to the newly-formed individual particles to become decoupled from the individual particles. The test procedure used to determine nickel fuzz content starts with a system of fresh solid particles containing substantially no loose particles below 44 microns and above 149 microns. A 250 milligram sample of the 44-149 micron solid particles is added to a solution of 20 cubic centimeters of deionized water and 12 cubic centimeters of Darvan-C™ surfactant (available from RT Vanderbilt Co. of Norwalk, Conn.). The resulting solid/liquid mixture is then gently stirred and introduced into a Malvern Mastersizer 2000™ particle size analyzer (available from Malvern Instruments Limited, Worcestershire, U.K.). The Mastersizer 2000™ then performs a standard automated particle size test and produces a report which includes volume percentages of various particles sizes. The turbulence in the Mastersizer 2000™ during the approximately 2 minute testing procedure causes substantially all of the nickel fuzz to be dislodged from the 44-149 micron particles introduced into the machine. The dislodged nickel fuzz particles are typically less than 20 microns. Thus, the total volume percent of sub 20 micron particles measured by the Mastersizer 2000™ is considered to be the nickel fuzz content of the solid particle system.

It is preferred for the nickel fuzz content of the fresh calcined promoted sorbent particles, described above, to be less than about 7 percent by volume, more preferably less than about 5 percent by volume, and most preferably less than about 3 percent by volume. Although the term “nickel fuzz” is used herein to refer to the layer of fuzz on the outside of the fresh sorbent particles, the composition of the fuzz may include components other than nickel.

In step (h), the calcined promoted sorbent particles are subjected to reduction with a suitable reducing agent, preferably hydrogen, under reducing conditions, to thereby provide reduced sorbent particles. Reduction can be carried out at a temperature in the range of from about 100° F. to about 1,500° F. and a pressure in the range of from about 15 psia to about 1,500 psia. Such reduction can be carried out for a time period sufficient to achieve the desired level of reduction, generally a time period in the range of from about 0.1 hour to about 20 hours.

During reduction of the calcined promoted sorbent particles, at least a portion of the metal oxides (e.g., nickel oxides, nickel-zinc oxides, and/or promoter metal oxides) are reduced to provide one or more reduced-valence metal components. Preferably, the reduction is effective to reduce the valence of substantially all the nickel oxide and/or nickel-zinc oxide present in the calcined sorbent particles. In the case of nickel oxide, reduction preferably converts substantially all of the nickel oxide to elemental nickel. In the case of nickel-zinc oxide, reduction preferably converts substantially all of the nickel-zinc oxide to a nickel-zinc substitutional solid solution characterized by the formula Ni_{A}Zn_{B}, wherein A and B are numerical values in the range of from about 0.01 to about 0.99. In the above formula for the nickel-zinc substitutional solid solution, it is preferred for A to be in the range of from about 0.70 to about 0.97, more preferably in the range of from about 0.80 to about 0.95, and most preferably in the range of from about 0.90 to about 0.94. It is further preferred for B to be in the range of from about 0.03 to about 0.30, more preferably in the range of from about 0.05 to about 0.20, and most preferably in the range of from about 0.06 to 0.10. Preferably, B is equal to (1-A). As used herein, the term “reduced-valence nickel” shall denote a nickel-containing component that initially had one or more oxygen atoms associated with it, but now has a reduced number of oxygen atoms associated with it due to reduction. Preferably, the reduced sorbent particles have a combined nickel oxide and nickel-zinc oxide content of less than about 2 weight percent, more preferably less than about 1 weight percent, and most preferably less than about 0.5 weight percent.

The reduced sorbent particles preferably comprise zinc oxide, the nickel-zinc substitutional solid solution (Ni_{A}Zn_{B}), nickel-zinc aluminate (Ni_{Z}Zn_{(1-Z)}Al₂O₄), the promoter (in elemental and/or oxide form), and the porosity enhancer (PE) in the ranges provided below in Table 3.

TABLE 3
Components of the Reduced Sorbent Particles

| | ZnO | Ni_{A}Zn_{B} | Ni_{A}Zn_{(1-Z)}Al₂O₄ | Promoter | PE |
|---|---|---|---|---|---|
| Range | (wt %) | (wt %) | (wt %) | (wt %) | (wt %) |
| Preferred | 10-80 | 5-80 | 1-50 | 0.5-10 | 5-50 |
| More | 20-60 | 20-60 | 5-30 | 1-5 | 10-40 |
| Preferred | | | | | |
| Most | 30-50 | 30-40 | 10-20 | 1.25-3 | 20-30 |
| Preferred | | | | | |

The physical properties of the reduced sorbent particles significantly affect their suitability for use in the desulfurization process, described in detail below. Important physical properties of the reduced sorbent particles include, for example, nickel fuzz content, particle shape, particle size, particle density, and resistance to attrition.

It is preferred for the nickel fuzz content of the reduced sorbent particles to be less than about 7 percent by volume, more preferably less than about 5 percent by volume, and most preferably less than about 3 percent by volume.

The reduced sorbent particles are preferably substantially microspherical particles having a mean particle size in the range of from about 10 to about 200 microns, more preferably in the range of from about 40 to about 150 microns, and most preferably in the range of from about 50 to about 100 microns.

The average density of the reduced sorbent particles is preferably in the range of from about 0.5 to about 1.5 grams per cubic centimeter (g/cc), more preferably in the range of from about 0.8 to about 1.3 g/cc, and most preferably in the range of from 0.9 to 1.2 g/cc.

The particle size and density of the sorbent particles preferably qualify the particles as Group A solids under the Geldart group classification system described in Powder Technol., 7, 285-292 (1973).

The reduced sorbent particles preferably have high resistance to attrition. As used herein, the term “attrition resistance” denotes a measure of a particle's resistance to size reduction under controlled conditions of turbulent motion. The attrition resistance of a particle can be quantified using the jet cup attrition test, similar to the Davidson Index. The Jet Cup Attrition Index represents the weight percent of the over 44 micrometer particle size fraction which is reduced to particle sizes of less than 37 micrometers under test conditions and involves screening a 5 gram sample of solid particles to remove particles in the 0 to 44 micrometer size range. The particles above 44 micrometers are then subjected to a tangential jet of air at a rate of 21 liters per minute introduced through a 0.0625 inch orifice fixed at the bottom of a specially designed jet cup (1″ I.D.×2″ height) for a period of 1 hour. The Jet Cup Attrition Index (JCAI) is calculated as follows:

$$JCAI = \frac{Wt . of 0 - 37 Micrometer Formed During Test}{Wt . of Original + 44 Micrometer Fraction Being Tested} \times 100 \times CF$$

The Correction Factor (CF) (presently 0.30) is determined by using a known calibration standard to adjust for differences in jet cup dimensions and wear. The sorbent and catalyst particles employed in the present invention preferably have a Jet Cup Attrition Index value of less than about 30, more preferably less than about 20, and most preferably less than 15.

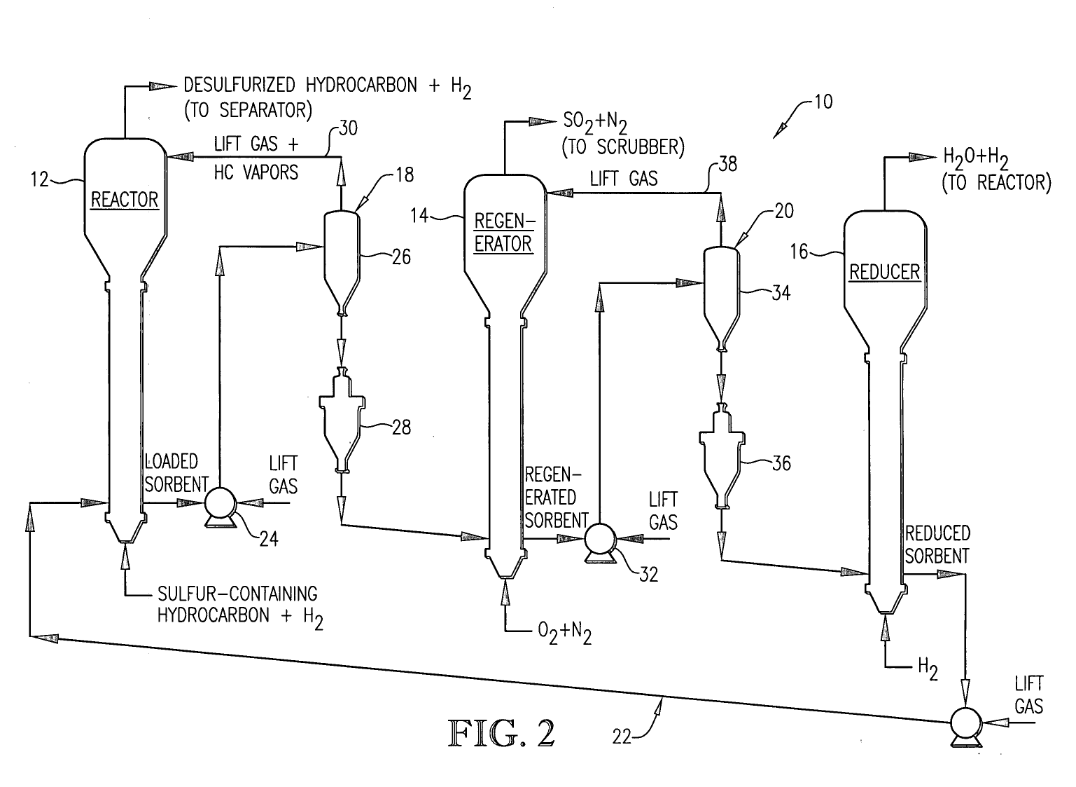

In one embodiment of the invention, the nickel-containing sorbent particles described above is employed in a process for removing sulfur from a hydrocarbon-containing stream. The desulfurization process is described below with reference to FIG. 2. In FIG. 2, a desulfurization unit 10 is illustrated as generally comprising a fluidized bed reactor 12, a fluidized bed regenerator 14, and a fluidized bed reducer 16. A system of finely divided solid particles is circulated in desulfurization unit 10 to provide for substantially continuous sulfur removal (in reactor 12) from a sulfur-containing hydrocarbon, such as cracked-gasoline or diesel fuel. In one embodiment of the present invention, the finely divided solid particle system employed in desulfurization unit 10 is formed solely of the nickel-containing sorbent particles described above. In another embodiment of the present invention, the finely divided solid particle system employed in desulfirization unit 10 is an unbound mixture of a plurality of individual nickel-containing sorbent particles and a plurality of individual catalyst particles. The remainder of this description is directed to an embodiment where the solid particulate system includes both sorbent and catalyst particles. However, the inventors note that the following description, unless contradictory, would also apply to a solid particulate system employing only sorbent particles. When both sorbent and catalysts particles are present in the solid particulate system, it is preferred for the weight ratio of the sorbent particles to the catalyst particles in the solid particulate system to be in the range of from about 100:1 to about 4:1, more preferably of from about 40:1 to about 5:1, and most preferably from 20:1 to 10:1.

When solid catalyst particles are employed in desulfurization unit 10, the catalyst particles can be any sufficiently fluidizable, circulatable, and regenerable solid acid catalyst having sufficient isomerization activity, cracking activity, attrition resistance, and coke resistance at the operating conditions of desulfurization unit 10. The catalyst particles are preferably more acidic than about −1 on the Hammett scale, more preferably the catalyst particles are more acidic than about −3 on the Hammett scale, and most preferably the catalyst particles are more acidic than −6 on the Hammett scale. The catalyst particles preferably comprise a zeolite in an amount in the range of from about 5 to about 50 weight percent, with the balance being a conventional binder system such as clay (e.g., kaolin clay) or a mixture of clay and a binding alumina. Most preferably, the catalyst particles comprise the zeolite in an amount in the range of from 10 to 30 weight percent. It is preferred for the largest ring of the zeolite employed in the catalyst particles of the present invention to have at least 8 T-atoms. More preferably, the largest ring of the zeolite has at least 10 T-atoms, still more preferably the largest ring of the zeolite has 10 to 12 T-atoms, and most preferably the largest ring of the zeolite has 10 T-atoms. It is further preferred for the zeolite to have a channel dimensionality of 3. It is preferred for the zeolite employed in the solid particulate system of the present invention to have a framework type code selected from the group consisting of AEL, AET, AFI, AFO, AFR, AFS, AFY, AHT, ASV, ATO, ATS, BEA, BEC, BOG, BPH, CAN, CFI, CGF, CGS, CLO, CON, CZP, DAC, DFO, DON, EMT, EPI, EUO, FAU, FER, GME, GON, HEU, IFR, ISV, LAU, LTL, MAZ, MEI, MEL, MFI, MFS, MOR, MTT, MTW, MWW, NES, OFF, OSI, OSO, PAR, RON, SAO, SBE, SBS, SBT, SFE, SFF, SFG, STF, STI, TER, TON, VET, VFI, WEI, and WEN. More preferably, the zeolite has a framework type code selected from the group consisting of AFS, AFY, BEA, BEC, BHP, CGS, CLO, CON, DFO, EMT, FAU, GME, ISV, MEI, MEL, MFI, SAO, SBS, SBT, and WEN. Still more preferably the zeolite has a MFI framework type code. The above-listed framework type codes follow the rules set up by an IUPAC Commission on Zeolite Nomenclature in 1978, as outlined in R. M. Barrer, “Chemical Nomenclature and Formulation of Compositions of Synthetic and Natural Zeolites,” Pure Appl. Chem. 51, 1091 (1979). Further information on framework type codes is available in Ch. Baerlocher, W. M. Meier, D. H. Olson, Atlas of zeolite Framework Types, 5th ed., Elsevier, Amsterdam (2001), the entire disclosure of which is hereby incorporated by reference. Most preferably, the zeolite of the catalyst particles is ZSM-5 that has been ion exchanged and calcined so that it exists in its hydrogen form (i.e., H-ZSM-5).

Referring again to FIG. 2, in fluidized bed reactor 12, a hydrocarbon-containing fluid stream is passed upwardly through a fluidized bed of the solid particulate system so that the reduced sorbent and catalyst particles present in reactor 12 are contacted with the fluid stream. As discussed above, the reduced sorbent particles contacted with the hydrocarbon-containing stream in reactor 12 preferably initially (i.e., immediately prior to contacting with the hydrocarbon-containing fluid stream) comprise zinc oxide and a reduced-valence nickel component. Though not wishing to be bound by theory, it is believed that the reduced-valence nickel component of the reduced sorbent particles facilitates the removal of sulfur from the hydrocarbon-containing stream, while the zinc oxide operates as a sulfur storage mechanism via its conversion to zinc sulfide.

The hydrocarbon-containing fluid stream contacted with the solid particulate system in reactor 12 preferably comprises a sulfur-containing hydrocarbon and hydrogen. The molar ratio of the hydrogen to the sulfur-containing hydrocarbon charged to reactor 12 is preferably in the range of from about 0.1:1 to about 3:1, more preferably in the range of from about 0.2:1 to about 1:1, and most preferably in the range of from 0.4:1 to 0.8:1. Preferably, the sulfur-containing hydrocarbon is a fluid which is normally in a liquid state at standard temperature and pressure, but which exists in a gaseous state when combined with hydrogen, as described above, and exposed to the desulfurization conditions in reactor 12. The sulfur-containing hydrocarbon preferably can be used as a fuel or a precursor to fuel. Examples of suitable sulfur-containing hydrocarbons include cracked-gasoline, diesel fuels, jet fuels, straight-run naphtha, straight-run distillates, coker gas oil, coker naphtha, alkylates, and straight-run gas oil. More preferably, the sulfur-containing hydrocarbon comprises a hydrocarbon fluid selected from the group consisting of gasoline, cracked-gasoline, diesel fuel, and mixtures thereof. Most preferably, the sulfur-containing hydrocarbon is cracked-gasoline.

As used herein, the term “gasoline” denotes a mixture of hydrocarbons boiling in a range of from about 100° F. to about 400° F., or any fraction thereof. Examples of suitable gasolines include, but are not limited to, hydrocarbon streams in refineries such as naphtha, straight-run naphtha, coker naphtha, catalytic gasoline, visbreaker naphtha, alkylates, isomerate, reformate, and the like, and mixtures thereof.

As used herein, the term “cracked-gasoline” denotes a mixture of hydrocarbons boiling in a range of from about 100° F. to about 400° F., or any fraction thereof, that are products of either thermal or catalytic processes that crack larger hydrocarbon molecules into smaller molecules. Examples of suitable thermal processes include, but are not limited to, coking, thermal cracking, visbreaking, and the like, and combinations thereof. Examples of suitable catalytic cracking processes include, but are not limited to, fluid catalytic cracking, heavy oil cracking, and the like, and combinations thereof. Thus, examples of suitable cracked-gasolines include, but are not limited to, coker gasoline, thermally cracked gasoline, visbreaker gasoline, fluid catalytically cracked-gasoline, heavy oil cracked-gasoline and the like, and combinations thereof. In some instances, the cracked-gasoline may be fractionated and/or hydrotreated prior to desulfurization when used as the sulfur-containing fluid in the process in the present invention.

As used herein, the term “diesel fuel” denotes a mixture of hydrocarbons boiling in a range of from about 300° F. to about 750° F., or any fraction thereof. Examples of suitable diesel fuels include, but are not limited to, light cycle oil, kerosene, jet fuel, straight-run diesel, hydrotreated diesel, and the like, and combinations thereof.

The sulfur-containing hydrocarbon described herein as suitable feed in the inventive desulfurization process comprises a quantity of olefins, aromatics, and sulfur, as well as paraffins and naphthenes. The amount of olefins in gaseous cracked-gasoline is generally in a range of from about 10 to about 35 weight percent based on the total weight of the gaseous cracked-gasoline. The amount of aromatics in gaseous cracked-gasoline is generally in a range of from about 20 to about 40 weight percent based on the total weight of the gaseous cracked-gasoline. The amount of atomic sulfur in the sulfur-containing hydrocarbon fluid, preferably cracked-gasoline, suitable for use in the inventive desulfurization process is generally greater than about 50 parts per million by weight (ppmw) of the sulfur-containing hydrocarbon fluid, more preferably in a range of from about 100 ppmw atomic sulfur to about 10,000 ppmw atomic sulfur, and most preferably from 150 ppmw atomic sulfur to 500 ppmw atomic sulfur. It is preferred for at least about 50 weight percent of the atomic sulfur present in the sulfur-containing hydrocarbon fluid employed in the present invention to be in the form of organosulfur compounds. More preferably, at least about 75 weight percent of the atomic sulfur present in the sulfur-containing hydrocarbon fluid is in the form of organosulfur compounds, and most preferably at least 90 weight percent of the atomic sulfur is in the form of organosulfur compounds. As used herein, “sulfur” used in conjunction with “ppmw sulfur” or the term “atomic sulfur”, denotes the amount of atomic sulfur (about 32 atomic mass units) in the sulfur-containing hydrocarbon, not the atomic mass, or weight, of a sulfur compound, such as an organosulfur compound.

As used herein, the term “sulfur” denotes sulfur in any form normally present in a sulfur-containing hydrocarbon such as cracked-gasoline or diesel fuel. Examples of such sulfur which can be removed from a sulfur-containing hydrocarbon fluid through the practice of the present invention include, but are not limited to, hydrogen sulfide, carbonyl sulfide (COS), carbon disulfide (CS₂), mercaptans (RSH), organic sulfides (R—S—R), organic disulfides (R—S—S—R), thiophene, substitute thiophenes, organic trisulfides, organic tetrasulfides, benzothiophene, alkyl thiophenes, alkyl benzothiophenes, alkyl dibenzothiophenes, and the like, and combinations thereof, as well as heavier molecular weights of the same which are normally present in sulfur-containing hydrocarbons of the types contemplated for use in the desulfurization process of the present invention, wherein each R can by an alkyl, cycloalkyl, or aryl group containing 1 to 10 carbon atoms.

As used herein, the term “fluid” denotes gas, liquid, vapor, and combinations thereof.

As used herein, the term “gaseous” denotes the state in which the sulfur-containing hydrocarbon fluid, such as cracked-gasoline or diesel fuel, is primarily in a gas or vapor phase.

Referring again to FIG. 2, in fluidized bed reactor 12, the solid particulate system is contacted with the upwardly flowing gaseous hydrocarbon-containing fluid stream under a set of desulfurization conditions sufficient to produce a desulfurized hydrocarbon, sulfur-loaded sorbent particles, and coked catalyst particles. The flow of the hydrocarbon-containing fluid stream is sufficient to fluidize the bed of solid particles located in reactor 12. The desulfirization conditions in reactor 12 include temperature, pressure, weighted hourly space velocity (WHSV), and superficial velocity. The preferred ranges for such desulfirization conditions are provided below in Table 4.

TABLE 4
Desulfurization Conditions

| | Temp. | Press. | WHSV | Superficial Vel. |
|---|---|---|---|---|
| Range | (° F.) | (psig) | (hr⁻¹) | (ft/s) |
| Preferred | 250-1200 | 25-750 | 1-20 | 0.25-5 |
| More Preferred | 500-1000 | 100-400 | 2-12 | 0.5-2.5 |
| Most Preferred | 700-850 | 150-250 | 3-8 | 1.0-1.5 |

When the reduced sorbent particles are contacted with the hydrocarbon-containing stream in reactor 12 under desulfurization conditions, sulfur compounds, particularly organosulfur compounds, present in the hydrocarbon-containing fluid stream are removed from such fluid stream. At least a portion of the sulfur removed from the hydrocarbon-containing fluid stream is employed to convert at least a portion of the zinc oxide of the reduced sorbent particles into zinc sulfide. In contrast to many conventional sulfur removal processes (e.g., hydrodesulfurization), it is preferred that substantially none of the sulfur in the sulfur-containing hydrocarbon fluid is converted to, and remains as, hydrogen sulfide during desulfurization in reactor 12. Rather, it is preferred that the fluid effluent from reactor 12 (generally comprising the desulfurized hydrocarbon and hydrogen) comprises less than the amount of hydrogen sulfide, if any, in the fluid feed charged to reactor 12 (generally comprising the sulfur-containing hydrocarbon and hydrogen). The fluid effluent from reactor 12 preferably contains less than about 50 weight percent of the amount of sulfur in the fluid feed charged to reactor 12, more preferably less than about 20 weight percent of the amount of sulfur in the fluid feed, and most preferably less than five weight percent of the amount of sulfur in the fluid feed. It is preferred for the total sulfur content of the fluid effluent from reactor 12 to be less than about 50 parts per million by weight (ppmw) of the total fluid effluent, more preferably less than about 30 ppmw, still more preferably less than about 15 ppmw, and most preferably less than 10 ppmw.

When the catalyst particles, if present, are contacted with the hydrocarbon-containing stream in reactor 12 under desulfurization conditions, it is preferred for the following reactions to take place: mild cracking of C7+ olefins, dealkylation of naphthenes, and isomerization of olefins from the alpha position to the beta position. The reactions catalyzed by the catalyst particles in reactor 12 provide an increase in the road octane of the resulting desulfurized product versus desulfurization with a solid particulate system employing no catalyst particles. As used herein, the terms “octane” and “road octane” shall denote the octane of a fuel calculated by summing the research octane number (RON) and the motor octane number (MON) and dividing the sum of the MON and RON by 2.

After desulfurization in reactor 12, the desulfurized hydrocarbon fluid, preferably desulfurized cracked-gasoline, can thereafter be separated and recovered from the fluid effluent and preferably liquified. The liquefication of such desulfurized hydrocarbon fluid can be accomplished by any method or manner known in the art. The resulting liquified, desulfurized hydrocarbon preferably comprises less than about 50 weight percent of the amount of sulfur in the sulfur-containing hydrocarbon (e.g., cracked-gasoline) charged to the reaction zone, more preferably less than about 20 weight percent of the amount of sulfur in the sulfur-containing hydrocarbon, and most preferably less than five weight percent of the amount of sulfur in the sulfur-containing hydrocarbon. The desulfurized hydrocarbon preferably comprises less than about 50 ppmw sulfur, more preferably less than about 30 ppmw sulfur, still more preferably less than about 15 ppmw sulfur, and most preferably less than 10 ppmw sulfur. It is further preferred for the desulfurized hydrocarbon to have an octane number that is at least 0.01 greater than the octane of the original sulfur-containing hydrocarbon charged to the reaction zone, more preferably 0.05 greater, still more preferably 0.1 greater, even more preferably 0.3 greater, and most preferably 0.5 greater.

After desulfurization in reactor 12, at least a portion of the solid particulate system (i.e., the sulfur-loaded sorbent particles and, optionally, the coked catalyst particles) are transported to regenerator 14 via a first transport assembly 18. In regenerator 14, the solid particulate system is contacted with an oxygen-containing regeneration stream. The oxygen-containing regeneration stream preferably comprises at least one mole percent oxygen with the remainder being a gaseous diluent. More preferably, the oxygen-containing regeneration stream comprises in the range of from about one to about 50 mole percent oxygen and in the range of from about 50 to about 95 mole percent nitrogen, still more preferable in the range of from about two to about 20 mole percent oxygen and in the range of from about 70 to about 90 mole percent nitrogen, and most preferably in the range of from three to 10 mole percent oxygen and in the range of from 75 to 85 mole percent nitrogen.

The regeneration conditions in regenerator 14 are sufficient to convert at least a portion of the zinc sulfide of the sulfur-loaded sorbent particles into zinc oxide via contacting with the oxygen-containing regeneration stream, thereby removing sulfur from the sorbent particles. In addition, the regeneration conditions are sufficient to remove at least a portion of the coke from the catalyst particles. The preferred ranges for such regeneration conditions are provided below in Table 5.

TABLE 5
Regeneration Conditions

| | Temp. | Press. | Superficial Vel. |
|---|---|---|---|
| Range | (° F.) | (psig) | (ft/s) |
| Preferred | 500-1500 | 10-250 | 0.5-10 |
| More Preferred | 700-1200 | 20-150 | 1.0-5.0 |
| Most Preferred | 900-1100 | 30-75 | 2.0-2.5 |

When the sulfur-loaded sorbent particles are contacted with the oxygen-containing regeneration stream under the regeneration conditions described above, at least a portion of the nickel component(s) is oxidized to form an oxidized nickel-containing component. Preferably, in regenerator 14 the nickel-zinc substitutional solid metal solution (Ni_{A}Zn_{B}) and/or sulfided nickel-zinc substitutional solid metal solution (Ni_{A}Zn_{B}S) of the sulfur-loaded sorbent is converted into the nickel-zinc oxide substitutional solid solution (Ni_{X}Zn_{(1-X)}O) described above.

The regenerated solid particulate system exiting regenerator 14 preferably comprises substantially sulfur-free sorbent particles and substantially coke-free catalyst particles. It is preferred for the substantially sulfur-free sorbent particles to have substantially the same component composition as the calcined promoted sorbent particles described above in Table 2.

After regeneration in regenerator 14, the regenerated solid particulate system is transported to reducer 16 via a second transport assembly 20. In reducer 16, the regenerated solid particles are contacted with a hydrogen-containing reducing stream. The hydrogen-containing reducing stream preferably comprises at least about 50 mole percent hydrogen with the remainder being cracked hydrocarbon products such as, for example, methane, ethane, and propane. More preferably, the hydrogen-containing reducing stream comprises at least about 70 mole percent hydrogen, and most preferably at least 80 mole percent hydrogen. The reducing conditions in reducer 16 are sufficient to reduce the valence of the nickel-containing component(s) of the regenerated solid sorbent particles. The preferred ranges for such reducing conditions are provided below in Table 6.

TABLE 6
Reducing Conditions

| | Temp. | Press. | Superficial Vel. |
|---|---|---|---|
| Range | (° F.) | (psig) | (ft/s) |
| Preferred | 250-1250 | 25-750 | 0.1-4.0 |
| More Preferred | 600-1000 | 100-400 | 0.2-2.0 |
| Most Preferred | 750-850 | 150-250 | 0.3-1.0 |

When the regenerated solid sorbent particles are contacted with the hydrogen-containing reducing stream in reducer 16 under the reducing conditions described above, at least a portion of the nickel-containing component is reduced to form reduced-valence nickel. It is preferred for the component composition of the reduced sorbent particles exiting reducer 16 to be substantially the same as the component composition of the reduced sorbent particles described above in Table 3.

After the system of solid particulates has been reduced in reducer 16, it can be transported back to reactor 12 via a third transport assembly 22 for recontacting with the hydrocarbon-containing fluid stream in reactor 12.

Referring again to FIG. 2, first transport assembly 18 generally comprises a reactor pneumatic lift 24, a reactor receiver 26, and a reactor lockhopper 28 fluidly disposed between reactor 12 and regenerator 14. During operation of desulfurization unit 10 the sulfur-loaded sorbent particles and coked catalyst particles are continuously withdrawn from reactor 12 and lifted by reactor pneumatic lift 24 from reactor 12 to reactor receiver 26. Reactor receiver 26 is fluidly coupled to reactor 12 via a reactor return line 30. The lift gas used to transport the solid particles from reactor 12 to reactor receiver 26 is separated from the solid particles in reactor receiver 26 and returned to reactor 12 via reactor return line 30. Reactor lockhopper 28 is operable to transition the solid particles from the high pressure hydrocarbon environment of reactor 12 and reactor receiver 26 to the low pressure oxygen environment of regenerator 14. To accomplish this transition, reactor lockhopper 28 periodically receives batches of the solid particles from reactor receiver 26, isolates the particles from reactor receiver 26 and regenerator 14, and changes the pressure and composition of the environment surrounding the particles from a high pressure hydrocarbon environment to a low pressure inert (e.g., nitrogen) environment. After the environment of the solid particles has been transitioned, as described above, the particles are batch-wise transported from reactor lockhopper 28 to regenerator 14. Because the solid particles are continuously withdrawn from reactor 12 but processed in a batch mode in reactor lockhopper 28, reactor receiver 26 functions as a surge vessel wherein the solid particles continuously withdrawn from reactor 12 can be accumulated between transfers of the particles from reactor receiver 26 to reactor lockhopper 28. Thus, reactor receiver 26 and reactor lockhopper 28 cooperate to transition the flow of the solid particles between reactor 12 and regenerator 14 from a continuous mode to a batch mode.

Second transport assembly 20 generally comprises a regenerator pneumatic lift 32, a regenerator receiver 34, and a regenerator lockhopper 36 fluidly disposed between regenerator 14 and reducer 16. During operation of desulfurization unit 10 the regenerated sorbent and catalyst particles are continuously withdrawn from regenerator 14 and lifted by regenerator pneumatic lift 32 from regenerator 14 to regenerator receiver 34. Regenerator receiver 34 is fluidly coupled to regenerator 14 via a regenerator return line 38. The lift gas used to transport the regenerated particles from regenerator 14 to regenerator receiver 34 is separated from the regenerated particles in regenerator receiver 34 and returned to regenerator 14 via regenerator return line 38. Regenerator lockhopper 36 is operable to transition the regenerated particles from the low pressure oxygen environment of regenerator 14 and regenerator receiver 34 to the high pressure hydrogen environment of reducer 16. To accomplish this transition, regenerator lockhopper 36 periodically receives batches of the regenerated particles from regenerator receiver 34, isolates the regenerated particles from regenerator receiver 34 and reducer 16, and changes the pressure and composition of the environment surrounding the regenerated particles from a low pressure oxygen environment to a high pressure hydrogen environment. After the environment of the regenerated particles has been transitioned, as described above, the regenerated particles are batch-wise transported from regenerator lockhopper 36 to reducer 16. Because the regenerated sorbent and catalyst particles are continuously withdrawn from regenerator 14 but processed in a batch mode in regenerator lockhopper 36, regenerator receiver 34 functions as a surge vessel wherein the particles continuously withdrawn from regenerator 14 can be accumulated between transfers of the regenerated particles from regenerator receiver 34 to regenerator lockhopper 36. Thus, regenerator receiver 34 and regenerator lockhopper 36 cooperate to transition the flow of the regenerated particles between regenerator 14 and reducer 16 from a continuous mode to a batch mode.

The following examples are intended to be illustrative of the present invention and to teach one of ordinary skill in the art to make and use the invention. These examples are not intended to limit the invention in any way.

### EXAMPLE 1

### Sorbent Preparation

This example describes the procedure used to prepare five nickel-containing sorbent compositions (i.e., Sorbents A-E). Sorbent A was a control sorbent that did not include a fuzz-reduction promoter. Sorbents B-E were impregnated with various promoters which were effective to reduce nickel fuzz content.

The unpromoted support particles used to make each Sorbent were prepared in the identical manner. The only difference between the preparation of the Sorbents occurred during impregnation of the Sorbents with the various metals (i.e., nickel and promoter metals). The unpromoted support particles were made in accordance with the following general steps:

(a) a support mixture was produced in the form of a slurry;

(b) the support mixture was spray dried to form support particles;

(c) the support particles were dried; and

(d) the dried support particles were calcined.

The support mixture was formed by combining in a first vessel 742 grams of distilled water, 11.3 grams of 1% nitric acid solution and stirring the resulting mixture for 5 minutes. A 166.3 gram quantity of expanded perlite (Harborlite™ 205, available from Harborlite Corporation, Antonito, Colo.) was then added to the first vessel under continuous stirring for 15 minutes. In a second vessel, 167.7 grams of aluminum hydroxide powder (Dispal® Alumina Powder, available from CONDEA Vista Company, Houston, Tex.) and 132 grams of kaolin clay were combined and stirred for 15 minutes. The contents of the first vessel were then added to the contents of the second vessel, and the resulting mixture was stirred for 15 minutes. A 616 gram quantity of zinc oxide powder (available from Zinc Corporation, Monaca, Pa.) was then added to the second vessel and stirred for 15 minutes. The resulting support mixture was in the form of a slurry containing 45 percent solids by weight.

The support mixture/slurry was formed into particles using a counter-current spray drier (Niro Atomizer Model 68, available from Niro Atomizer, Inc., Columbia, Md.). The support mixture/slurry was fed to the spray drier at a rate of 40 grams per minute wherein it was contacted in a particulating chamber with air flowing through the chamber. The inlet temperature of air to the particulating chamber was about 280-320° C., while the air outlet temperature was about 110° C. The resulting spray-dried support particles were sieved to remove particles smaller than 44 microns and larger than 149 microns.

The sieved support particles were then placed in an oven and dried by ramping the oven temperature at 3° C./min to 150° C. and holding at 150° C. for 1 hour. The dried support particles were then calcined by ramping the oven temperature at 5° C./min to 635° C. and holding at 635° C. for 1 hour. The resulting calcined particles were the unpromoted support particles used to create Sorbents A-E, described below.

Sorbent A was formed by impregnating the calcined support particles with nickel, and then drying and calcining the resulting nickel-promoted sorbent. Impregnation was accomplished by spraying nickel nitrate hexahydrate onto a 100.0 gram quantity of the calcined support particles using standard incipient wetness techniques. The impregnated sorbent particles were then put in an oven and dried by ramping the oven temperature at 3° C./min to 150° C. and holding at 150° C. for 1 hour. The dried sorbent was then calcined by ramping the oven temperature at 5° C./min to 635° C. and holding at 635° C. for 1 hour. The resulting sorbent, containing 16 weight percent nickel (elemental+oxide), was designated Sorbent A.

Sorbent B was formed by impregnating the calcined support particles with nickel and magnesium, and then drying and calcining the resulting promoted sorbent. Impregnation was accomplished by spraying a mixture containing 88.1 weight percent nickel nitrate hexahydrate and 11.9 weight percent magnesium nitrate hexahydrate onto a 100.0 gram quantity of the calcined support particles using standard incipient wetness techniques. The impregnated sorbent particles were then put in an oven and dried by ramping the oven temperature at 3° C./min to 150° C. and holding at 150° C. for 1 hour. The dried sorbent was then calcined by ramping the oven temperature at 5° C./min to 635° C. and holding at 635° C. for 1 hour. The resulting sorbent, containing 16 weight percent nickel (elemental+oxide) and 2 percent magnesium oxide, was designated Sorbent B.

Sorbent C was formed by impregnating the calcined support particles with nickel and calcium, and then drying and calcining the resulting promoted sorbent. Impregnation was accomplished by spraying a mixture containing 91.8 weight percent nickel nitrate hexahydrate and 8.2 weight percent calcium nitrate tetrahydrate onto a 100.0 gram quantity of the calcined support particles using standard incipient wetness techniques. The impregnated sorbent particles were then put in an oven and dried by ramping the oven temperature at 3° C./min to 150° C. and holding at 150° C. for 1 hour. The dried sorbent was then calcined by ramping the oven temperature at 5° C./min to 635° C. and holding at 635° C. for 1 hour. The resulting sorbent, containing 16 weight percent nickel (elemental+oxide) and 2 percent calcium oxide, was designated Sorbent C.

Sorbent D was formed by impregnating the calcined support particles with nickel and barium, and then drying and calcining the resulting promoted sorbent. Impregnation was accomplished in two steps. The first impregnation was performed by spraying a mixture containing 95.0 weight percent nickel nitrate hexahydrate and 5.0 weight percent water onto a 100.0 gram quantity of the calcined support particles using standard incipient wetness techniques. The nickel-impregnated sorbent particles were then put in an oven and dried at 100° C. for 2 hours. The dried, nickel-impregnated particles were then impregnated with barium by spraying a solution of 9.6 weight percent barium nitrate and 90.4 weight percent distilled water onto the nickel-impregnated particles using standard incipient wetness techniques. The barium-impregnated sorbent particles were then put in an oven and dried by ramping the oven temperature at 3° C./min to 150° C. and holding at 150° C. for 1 hour. The dried sorbent was then calcined by ramping the oven temperature at 5° C./min to 635° C. and holding at 635° C. for 1 hour. The resulting sorbent, containing 16 weight percent nickel (elemental+oxide) and 2 percent barium oxide, was designated Sorbent D.

Sorbent E was formed by impregnating the calcined support particles with nickel and cerium, and then drying and calcining the resulting promoted sorbent. Impregnation was accomplished by spraying a mixture containing 93.5 weight percent nickel nitrate hexahydrate, 1.5 weight percent water, and 5.0 weight percent cerium nitrate hexahydrate onto a 100.0 gram quantity of the calcined support particles using standard incipient wetness techniques. The impregnated sorbent particles were then put in an oven and dried by ramping the oven temperature at 3° C./min to 150° C. and holding at 150° C. for 1 hour. The dried sorbent was then calcined by ramping the oven temperature at 5° C./min to 635° C. and holding at 635° C. for 1 hour. The resulting sorbent, containing 16 weight percent nickel (elemental+oxide) and 2 percent cerium oxide, was designated Sorbent E.

### EXAMPLE 2

### Determination of Nickel Fuzz Content

This example describes the procedure used to determine the nickel fuzz content of Sorbents A-E. As discussed in the Detailed Description section of this document, the term “nickel fuzz content” denotes the volume percent of sub 20 micron particles present in a system of fresh solid particles measured in a Malvern Mastersizer 2000™ particle size analyzer, in accordance with the test procedure described below.

The test procedure used to determine nickel fuzz content was commenced by adding a 250 milligram sample of the sorbent particles (having been previously sieved to 44-149 microns) to a solution of 20 cubic centimeters of dionized water and 12 cubic centimeters of Darvan-C™ surfactant (available from RT Vanderbilt Co. of Norwalk, Conn.). The resulting solid/liquid mixture was then gently stirred and introduced into a Malvern Mastersizer 2000™ particle size analyzer (available from Melvern Instruments Limited, Worcestershire, U.K.). The Mastersizer 2000™ then performed a standard 2 minute automated particles size test and produced a report which included volume percentages of various particles sizes. The turbulence in the Mastersizer 2000™ during testing caused substantially all of the nickel fuzz to be dislodged from the 44-149 micron particles introduced into the machine. The total volume percent of sub 20 micron particles measured by the Mastersizer 2000™ was the nickel fuzz content of the sorbent.

Table 7, below, summarizes the results of the nickel fuzz content tests performed on sorbents A-E.

TABLE 7

| | | Promoter | | |
|---|---|---|---|---|
| | | Amount | Nickel Amount | Ni Fuzz Content |
| Sorbent | Promoter | (wt. %) | (wt. %) | (vol. %) |
| A | None | 0 | 16 | 7.4 |
| B | Mg Oxide | 2 | 16 | 5.6 |
| C | Ca Oxide | 2 | 16 | 3.8 |
| D | Ba Oxide | 2 | 16 | 5.5 |
| E | Ce Oxide | 2 | 16 | 2.5 |

The results summarized in Table 7 clearly show that Sorbents B-E (promoted with Mg, Ca, Ba, and Ce oxides) had a reduced nickel fuzz content as compared to Sorbent A (no promoter). Reasonable variations, modifications, and adaptations may be made within the scope of this disclosure and the appended claims without departing from the scope of this invention.

What is claimed is:

1. A sorbent system comprising a plurality of fresh sorbent particles, wherein said fresh sorbent particles comprise zinc oxide and nickel, wherein said sorbent system has a mean particle size of less than about 500 microns, wherein said sorbent system has a nickel fuzz content of less than about 7 percent by volume.

2. The sorbent system of claim 1, wherein said sorbent particles further comprise a promoter selected from the group consisting of lanthanum, cerium, praseodymium, neodymium, promethium, samarium, europium, gadolinium, terbium, dysprosium, holmium, erbium, thulium, ytterbium, lutetium, lithium, sodium, potassium, rubidium, cesium, francium, beryllium, magnesium, calcium, strontium, barium, radium, oxides thereof, and combinations thereof.

3. The sorbent system of claim 2, wherein said sorbent particles comprise in the range of from about 5 to about 50 weight percent of said nickel, in the range of from about 10 to about 80 weight percent of said zinc oxide, and in the range of from about 0.5 to about 10 weight percent of said promoter.

4. The sorbent system of claim 1, wherein said sorbent particles further comprise a promoter selected from the group consisting of magnesium, calcium, barium, cerium, oxides thereof, and combinations thereof.

5. The sorbent system of claim 4, wherein said sorbent particles comprise in the range of from about 8 to about 40 weight percent of said nickel, in the range of from about 20 to about 60 weight percent of said zinc oxide, and in the range of from about 1 to about 5 weight percent of said promoter.

6. The sorbent system of claim 1, wherein said sorbent particles further comprise a promoter selected from the group consisting of calcium, cerium, oxides thereof, and combinations thereof, wherein said sorbent system has a nickel fuzz content of less than about 5 percent by volume.

7. The sorbent system of claim 6, wherein said promoter is cerium, cerium oxide, or a combination thereof, wherein said sorbent system has a nickel fuzz content of less than 3 percent by volume.

8. The sorbent system of claim 7, wherein said sorbent particles comprise in the range of from about 1 to about 5 weight percent of said promoter.

9. The sorbent system of claim 8, wherein said sorbent particles comprise in the range of from about 5 to about 50 weight percent of said nickel and in the range of from about 10 to about 80 weight percent of said zinc oxide, wherein said sorbent system has a mean particle size in the range of from about 10 microns to about 200 microns.

10. The sorbent system of claim 1, wherein substantially all of said nickel is in reduced-valence form.

11. The sorbent system of claim 1, wherein said sorbent particles comprise less than about 2 weight percent nickel oxide and nickel-zinc oxide.

12. The sorbent system of claim 1, wherein said sorbent particles further comprise an aluminate.

13. The sorbent system of claim 1, wherein said sorbent particles further comprise a nickel-zinc substitutional solid solution and/or an oxide thereof.

14. The sorbent system of claim 1, wherein said sorbent particles further comprise perlite.

15. A sorbent system formed of a plurality of fresh sorbent particles, said sorbent particles comprising:
zinc oxide in an amount in the range of from about 10 to about 80 weight percent;
a nickel-zinc substitutional solid solution and/or oxide thereof; and
a promoter selected from the group consisting of magnesium, calcium, barium, cerium, oxides thereof, and combinations thereof, wherein said promoter is present in an amount in the range of from about 0.5 to about 10 weight percent, wherein said sorbent system has a mean particle size in the range of from about 10 to about 200 microns.

16. The sorbent system of claim 15, wherein said sorbent system has a nickel fuzz content of less than about 7 percent by volume.

17. The sorbent system of claim 15, wherein said sorbent particles further comprise an aluminate.

18. The sorbent system of claim 15, wherein said sorbent particles further comprise perlite.

19. The sorbent system of claim 19, wherein said sorbent particles comprise less than 2 weight percent of nickel oxide and nickel-zinc oxide.

20. A method of producing a sorbent composition, said method comprising:
(a) forming a support mixture comprising zinc oxide and alumina;
(b) particulating the support mixture to thereby form a plurality of support particles having a mean particle size less than about 500 microns;
(c) incorporating nickel and a non-nickel promoter onto and/or into said support particles to thereby provide promoted particles, wherein said non-nickel promoter is selected from the group consisting of lanthanum, cerium, praseodymium, neodymium, promethium, samarium, europium, gadolinium, terbium, dysprosium, holmium, erbium, thulium, ytterbium, lutetium, lithium, sodium, potassium, rubidium, cesium, francium, beryllium, magnesium, calcium, strontium, barium, radium, oxides thereof, and combinations thereof; and
(d) calcining said promoted particles to thereby provide calcined promoted particles.

21. The method of claim 20, wherein said promoter is incorporated in an amount effective to reduce the nickel fuzz content of said calcined promoted particles.

22. The method of claim 20, wherein said calcined promoted particles have a nickel fuzz content of less than about 7 percent by volume.

23. The method of claim 20, wherein said calcined promoted particles comprise said promoter in an amount in the range of from about 0.5 to about 10 weight percent.

24. The method of claim 23, wherein said calcined promoted particles comprise said nickel in an amount in the range of from about 5 to about 50 weight percent and said zinc oxide in an amount in the range of from about 10 to about 80 weight percent.

25. The method of claim 20, wherein said promoter is selected from the group consisting of calcium, cerium, oxides thereof, and combinations thereof, wherein said calcined promoted particles have a nickel fuzz content of less than about 5 percent by volume.

26. The method of claim 20, wherein said promoter is cerium, cerium oxide, or a combination thereof, wherein said calcined promoted particles contain said promoter in an amount in the range of from about 1 to about 5 weight percent, wherein said calcined promoted particles have a nickle fuzz content of less than 3 percent by volume.

27. The method of claim 20, further comprising reducing said calcined promoted particles.

28. A process for removing sulfur from a hydrocarbon-containing fluid stream, said process comprising:
(a) contacting said hydrocarbon-containing fluid stream with a sorbent composition comprising zinc oxide, nickel, and a non-nickel promoter in a desulfurization zone under conditions such that there is formed a desulfurized fluid stream and a sulfurized sorbent, wherein said non-nickel promoter is selected from the group consisting of lanthanum, cerium, praseodymium, neodymium, promethium, samarium, europium, gadolinium, terbium, dysprosium, holmium, erbium, thulium, ytterbium, lutetium, lithium, sodium, potassium, rubidium, cesium, francium, beryllium, magnesium, calcium, strontium, barium, radium, oxides thereof, and combinations thereof;
(b) regenerating at least a portion of said sulfurized sorbent in a regeneration zone so as to remove at least a portion of the sulfur therefrom and provide a desulfurized sorbent;
(c) reducing said desulfurized sorbent in an activation zone to provide a reduced sorbent composition which will affect the removal of sulfur from said hydrocarbon-containing fluid stream when contacted with the same; and
(d) returning at least a portion of said reduced sorbent composition to said desulfurization zone.

29. The process of claim 28, wherein said promoter is selected from the group consisting of magnesium, calcium, barium, cerium, oxides thereof, and combinations thereof.

30. The process of claim 28, wherein said sorbent composition comprises said nickel in an amount in the range of from about 5 to about 50 weight percent, said zinc oxide in an amount in the range of from about 10 to about 80 weight percent, and said promoter in an amount in the range of from about 0.5 to about 10 weight percent.

31. The process of claim 28, wherein said sorbent composition has a mean particle size in the range of from about 10 to about 200 microns.

32. The process of claim 28, wherein said promoter is selected from the group consisting of calcium, cerium, oxides thereof, and combinations thereof.

33. The process of claim 28, wherein said promoter is cerium, cerium oxide, or a combination thereof, wherein said sorbent composition comprises in the range of from about 1 to about 5 weight percent of said promoter.
